(19) United States
(12) Patent Application Publication
(10) Pub. No.: US 2014/0319823 A1
(43) Pub. Date: Oct. 30, 2014

(54) DEVICE FOR CONNECTING TWO CONDUIT SECTIONS

(71) Applicant: ILLINOIS TOOL WORKS INC., Glenview, IL (US)

(72) Inventor: Johannes Happich, Schifferstadt (DE)

(21) Appl. No.: 14/356,617

(22) PCT Filed: Nov. 8, 2012
(86) PCT No.: PCT/US2012/064079

§ 371 Date: May 7, 2014

(30) Foreign Application Priority Data
Nov. 10, 2011 (DE) 10 2011 118 099.4

(51) Int. Cl. F16L 37/10; F16L 37/133

(52) U.S. Cl. CPC F16L 37/10; F16L 37/133
USPC 285/309

(57) ABSTRACT

The invention relates to a device for connecting two conduit sections of an automobile conduit, comprising a plug element and a basic body with a receptacle for the plug element, wherein the plug element comprises at least one catch element and the receptacle comprises at least one catch element corresponding to the catch element of the plug element, wherein the catch elements releasably engage with one another upon insertion of the plug element into the receptacle and a locking mechanism is provided which impedes a release of the engagement of the catch elements in a locking position and which allows a release of the engagement of the catch elements in an unlocking position.

The invention relates to a device for connecting two conduit sections of an automobile conduit, comprising a plug element and a basic body with a receptacle for the plug element. Devices of this kind are used as the coupling element in fluid conduits in an automobile, for example oil conduits. The plug element in this case is connected to one of the two conduit sections and the basic body is connected to the other of the two conduit sections. To make the connection, the plug element is inserted into the receptacle of the basic body, usually by pressing. A tight connection of the conduit sections with one another is thereby achieved. Plug connectors of this kind are standardized by the Society of Automotive Engineers (SAE). The disadvantage of the known devices is that non-destructive disassembly of the plug element from the receptacle for access to the conduit sections is not possible.

Starting from the state of the art as described, the problem addressed by the invention is that of providing a device of the kind mentioned above, with which a secure connection can be simply created between two conduit sections of an automobile conduit, wherein simple, non-destructive disassembly of the device should likewise be possible.

The invention solves this problem by means of the subject matter of claim 1. Advantageous embodiments can be found in the dependent claims, the description and the figures.

For a device of the kind mentioned above, the invention solves the problem in that the plug element comprises at least one catch element and that the receptacle comprises at least one catch element corresponding to the catch element of the plug element, wherein the catch elements releasably engage with one other upon insertion of the plug element into the receptacle, and in that a locking mechanism is provided which impedes a release of the engagement of the catch elements in a locking position and which allows a release of the engagement of the catch elements in an unlocking position.

The conduit may be a conduit for a fluid, particularly a fluid for running an automobile. It may be an oil conduit, for example. It is also possible, however, that the conduit is a water or fuel-conducting conduit for the automobile. The plug element has a through-opening for the fluid to be conveyed through the conduit. The basic body likewise has a through-opening for the fluid to be conveyed through the conduit. When the plug element is in a state inserted into the receptacle of the basic body, the through-openings are aligned with one another. The through-openings may have a circular cross section, for example. The receptacle may be formed by an inner wall of the through-opening of the basic body. As mentioned above, the plug element is connectable or connected to the first of the two conduit sections to be connected to one another. The basic body is connectable or connected to the second of the two conduit sections to be connected to one another. A coupling for the two conduit sections to be connected to one another is thereby formed by the device.

According to the invention, when the plug element is inserted into the receptacle, a releasable engagement takes place. By releasing the engagement, the plug element can therefore be advantageously disassembled in a non-destructive manner, so that there is access to the conduit sections connected to one another, for maintenance or repair purposes for example. The catch elements provided according to the invention may particularly be catch recesses and/or catch projections. The plug element and/or the basic body may each comprise one or a plurality of catch elements. Furthermore, a locking mechanism is provided according to the invention, which is adjustable between a locking position and an unlocking position. It is ensured by means of the locking mechanism that the plug element cannot be released from the receptacle in an undesirable manner, accidentally for example, during operation. Instead, the locking element must first be moved into the unlocking position. The plug element can then be disassembled from the receptacle. According to the invention, a secure connection between two conduit sections of an automobile conduit is thereby achieved in an easy-to-assemble manner. At the same time, simple, non-destructive disassembly of the device is likewise possible. An unwanted release of the engagement is reliably impeded by the locking mechanism.

The plug element may be a standard component, apart from the at least one catch element, according to a Society of Automotive Engineers (SAE) standard, for example.

According to one embodiment, the at least one catch element of the plug element may comprise a circumferential groove provided on the outside of the plug element or a circumferential projection provided on the outside of the plug element. The plug element may have a cylindrical outer surface, in which the circumferential groove or on which the circumferential projection is formed. The circumferential projection may be configured as a flange. According to a further embodiment, the at least one catch element of the receptacle may comprise at least one elastic catch arm in the radial direction of the receptacle, on the free end of which a catch projection is provided. The catch arm is particularly securely articulated at its one end. The other end of the catch arm is free and supports a catch projection. A catch hook is thereby formed. The catch projections of the catch arms may then engage in a circumferential groove, for example, or behind a circumferential flange or projection of the plug element. A plurality of such catch arms may be provided. The at least one catch arm is movable at least in a radial direction, in other words perpendicular to the axial direction of the receptacle. The axial direction of the receptacle is particularly defined by the insertion direction of the plug element into the receptacle. It is usually simultaneously the axial direction of the conduit sections to be connected to one another by the device according to the invention, in other words of the flow direction of a fluid through the conduit. The catch projection or projections may extend inwards in a radial direction starting from the catch arm or arms. Furthermore, it may be provided that the at least one catch arm is disposed with its end opposite the free end on a holding ring of the catch element, said holding ring being held on the basic body. The catch arm or arms may in this case be configured integrally with the holding ring.

According to a further embodiment, the locking mechanism may comprise a locking sleeve disposed on the basic body and being rotatable between the unlocking position and the locking position. The locking sleeve may impede an outward movement of the at least one catch arm at least in a radial direction. A particularly simple realization of the lock is thereby achieved. The locking sleeve may be slipped onto the basic body. In particular, it may also be slipped onto the holding ring and/or the at least one catch arm of the catch element of the receptacle. By simply turning the locking sleeve, whether manually or by means of a tool, the plug element can then be locked and unlocked in the receptacle.

Furthermore, it may be provided that the locking sleeve possesses an inner radius which changes in the circumferential direction, wherein in the locking position at least one section with a smaller inner radius is located in a radial direction above the catch projection, in other words, outside the catch projection, of the at least one catch arm, so that the at least one catch arm cannot move outwards in a radial direction and wherein in the unlocking position at least one section with a larger inner radius is located in a radial direction above the catch projection of the at least one catch arm, so that the at least one catch arm can move outwards in a radial direction to release the engagement of the plug element in the receptacle. The change in the inner radius in this case may particularly be in a (first) axial section of the locking sleeve. This axial section is particularly the axial section in which the catch projections are also disposed when the device is in the assembled state. The inner radius may regularly change over the circumference, for example. The change may be continuous in each case, so that graduations can be avoided and rotation of the locking sleeve simplified. In particular, hill-like elevations may for example be provided on the inner surface of the locking sleeve, in a number and position corresponding to the number and position over the circumference of the basic body or the receptacle of the catch arms and catch projections provided. If, for example, four catch projections and catch arms evenly distributed over the circumference of the receptacle are provided, four projections likewise evenly distributed over the circumference of the inner surface of the locking sleeve may be correspondingly provided. By rotating the locking sleeve, the elevations can likewise be moved into a position above the catch projections, so that the catch arms and with them the catch projections cannot be moved outwards in a radial direction. The engagement of the plug element in the receptacle is therefore prevented from releasing. To release the engagement, the locking sleeve must first be turned until the sections with a larger inner diameter are each above the catch projections in a radial direction. The catch projections can then spring outwards with the catch arms, so that the engagement of the plug element can be released. Furthermore, the locking sleeve may exhibit at least one receptacle for the at least one catch projection on its inner surface close to the at least one section with a larger inner diameter.

According to a further embodiment, it may be provided that the at least one catch element of the receptacle furthermore comprises at least one safety arm being elastic at least in a radial direction of the receptacle, on the free end of which a safety projection is provided, wherein the at least one safety projection is offset in an axial direction with regard to the at least one locking projection of the locking element of the receptacle. The at least one safety arm may be disposed with its end opposite the free end likewise on the holding ring held on the basic body. The safety arms along with the safety projections form safety hooks. The safety arms may be of a different length to the catch arms in this case, for example they may be shorter. In this way it can be achieved, with the same starting point on the holding ring, that the catch projections are arranged on a different axial plane to the safety projections. Moreover, a plurality of such safety arms may be provided. While the catch projection or projections may extend inwards in a radial direction starting from the catch arm or arms, it is possible for the safety projection or projections to extend outwards in a radial direction from the safety arm or safety arms.

According to a further embodiment, the locking sleeve may exhibit at least one through-opening into which at least one safety projection enters in the locking position of the locking sleeve, so that a rotation of the locking sleeve out of its locking position into its unlocking position is impeded. The safety projections in this case are spring-preloaded, such that they automatically enter the through-opening and remain therein when the locking sleeve is located in the locking position. A rotation of the locking sleeve out of its locking position into its unlocking position is only possible if beforehand the safety projection or projections is/are pressed against their spring-preloading from the outside through the through-hole out of said through-hole inwards in a radial direction. This requires a special disassembly tool, a suitable pair of pliers for example, so that the plug element cannot be released from the receptacle during operation in an unwanted fashion. It is possible that a corresponding through-opening is not provided for all safety projections. In this way, the disassembly tool need not press all safety projections inward. The engagement of the tool and therefore the disassembly are thereby simplified.

The plug element and/or the basic body and/or the catch elements may be made of a plastic. This is particularly simple from a manufacturing point of view. Moreover, this makes the components particularly light and inexpensive. The releasable engagement according to the invention means that a plastics material of this kind is possible for the present application.

The basic body and the catch element of the receptacle may be formed by a common component, in other words integrally formed. It is also possible, however, for the basic body and the catch element to be separate components. It is then further advantageously possible for the basic body to be made of a harder material than the at least one catch element of the receptacle. On the one hand, a high degree of stability is thereby achieved through the hard basic body. At the same time, simple assembly and disassembly is achieved through the softer catch element.

An exemplary embodiment of the invention is explained in greater detail below with the help of figures. These show in schematic form:

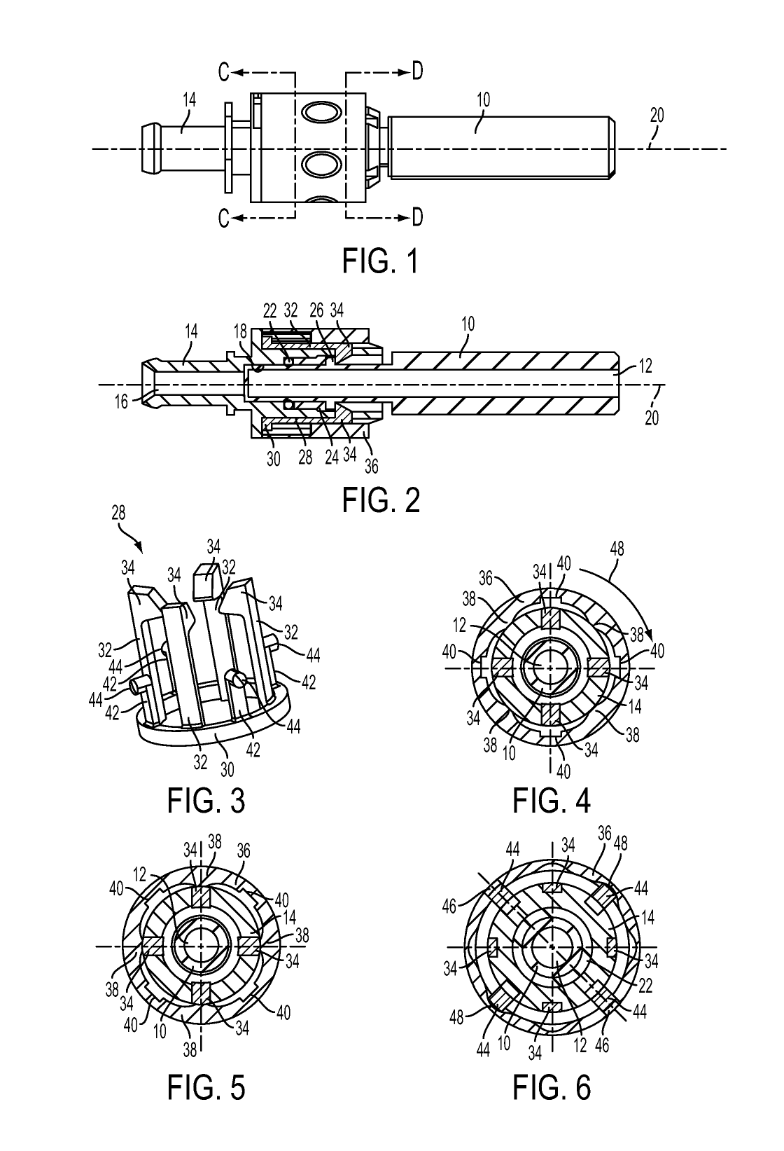

FIG. 1 a device according to the invention in the assembled state in side view,

FIG. 2 the device from FIG. 1 in a longitudinal sectional view,

FIG. 3 the catch element of the receptacle of the device according to the invention shown in FIG. 2 in a perspective view,

FIG. 4 a section along line D-D in FIG. 1 in a first operating position,

FIG. 5 a section along line D-D in FIG. 1 in a second operating position and

FIG. 6 a section along line C-C in FIG. 1.

Unless otherwise indicated, the same reference numbers in the figures denote the same items. The device according to the invention shown in FIG. 1 is used to connect two conduit sections which are not shown of a fluid conduit of an automobile, for example an oil conduit. It comprises a plug element 10 which, as can be seen particularly in FIG. 2, comprises two hollow-cylindrical sections having different outer diameters. The plug element 10 delimits a cylindrical through-opening 12 with a uniform diameter for the fluid to be conducted through the automobile conduit. The device further comprises a basic body 14, which likewise delimits a through-opening 16 with a circular cross section for the fluid to be conducted through the conduit. The plug element 10 is inserted into a receptacle 18 formed by the through-opening 16 with its section having the reduced outer diameter, as can be particularly seen in FIG. 2. During operation the plug element 10 is connected to a first of the two conduit sections and the basic body 14 to a second of the two conduit sections. The fluid flows through the conduit sections and the through-openings 12, 16 of the device along the axial direction shown in FIGS. 1 and 2 with the reference number 20. Reference number 22 in FIG. 2 denotes a sealing ring, in this case an O-ring, which seals the connection between the conduit sections made by the device according to the invention. A clamping ring 24 is secured to the inside of the basic body 14, which ensures that the sealing ring 22 is held on the basic body 14 before the plug element 10 is inserted into the receptacle 18 of the sealing ring 22.

It can be seen particularly in FIG. 2 that the plug element 10 comprises a flange 26 running in the circumferential direction as the catch element on its section disposed within the receptacle 18. A corresponding catch element 28 is disposed on the basic body 14, said catch element being shown in FIG. 3 in a perspective view. The catch element 28 comprises a holding ring 30, with which it is pushed onto the basic body 14, as can be seen in FIG. 2. Starting from the holding ring 30, four elastic catch arms 32 extend in the example shown, on the free end of which a catch projection 34 disposed inwardly in a radial direction is configured in each case. Four engaging hooks are thereby formed distributed at even intervals around the circumference of the holding ring 30. When the plug element 10 is inserted into the receptacle 18, the catch projections 34 and with them the catch arms 32 are initially pressed outwards in a radial direction by the circumferential flange 26 of the plug element 10 until they engage behind the circumferential flange 26, as shown in FIG. 2. For disassembly, it is possible in this case to pull the plug element 10 out of the receptacle 18 again, wherein the catch projections 34 and with them the catch arms 32 are pressed outwards again in a radial direction until the circumferential flange 26 slips past the catch projections 34.

The assembly and disassembly of the plug element 10 described above is, however, only possible if a locking mechanism of the device according to the invention is in an unlocking position. In the example shown, the locking mechanism comprises a locking sleeve 36 slipped onto the basic body 14 and the catch element 28. The embodiment and function of the locking sleeve 36 is to be explained in greater detail with reference to FIGS. 4 and 5. It can be seen here that the locking sleeve 36 exhibits an inner diameter that changes in the circumferential direction. The locking sleeve 36 is particularly provided on its inner side with four hill-like elevations 38 which are evenly distributed over the circumference. Between the elevations 38 in each case are likewise four receptacles 40 evenly distributed over the inner circumference of the locking sleeve 36. The unlocking position of the locking sleeve 36 is shown in FIG. 4. It can be seen that in this position the receptacles 40 each lie in a radial direction above or outside the catch projections 34. The catch projections 34 and with them the catch arms 32 can move outwards in this unlocking position, in a radial direction in other words, particularly for assembly and disassembly of the plug element 10. To achieve the locking position, the locking sleeve 36 is rotated out of the position show in FIG. 4 along the arrow 48 into the locking position shown in FIG. 5. In this locking position the elevations 38 of the locking sleeve 36 are located above or outside the catch projections 34 in a radial direction. The catch projections 34 cannot therefore be moved outwards in a radial direction in this state. Releasing the engagement of the plug element 10 at the catch projections 34 is not therefore possible, so that a disassembly of the plug element 10 in this state is not possible either.

A safety function of the device according to the invention impeding accidental movement of the locking sleeve 36 into the unlocking position is to be explained using the section along line C-C in FIG. 1 shown in FIG. 6. For this purpose, reference is initially made once again to FIG. 3. It is possible to see here that apart from the catch arms 32, the catch element 28 also exhibits four elastic safety arms 42 disposed between two catch arms 32 in each case extending at even intervals on the circumference from the holding ring 30. At their free end, a safety projection 44 is configured on each of the safety arms 42. The safety projections 44 extend in the example shown outwards in a radial direction. In FIG. 6, in which the locking sleeve 36 is located in its locking position, it can be seen that said sleeve exhibits two diametrically opposite through-openings 46 on the axial plane shown there. Moreover, it exhibits two protrusions 48 on its inner surface, likewise diametrically opposite one another. The through-openings 46 and the protrusions 48 are evenly distributed over the inner circumference of the locking sleeve 36 and, as can be seen in FIG. 6, arranged in the locking position in a radial direction above or outside a safety projection 44 in each case. In particular, the safety projections 44 located below or within the through-openings 46 in a radial direction have entered the through-openings 46 due to the spring-preloading of the safety arms 42. This means that a rotation of the locking sleeve 36 out of the locking position shown in FIG. 6 is no longer possible. Instead, a special tool is required for this, a pair of pliers for example, which initially presses the safety projections 44 against their spring-preloading inwards in a radial direction from the through-openings 46.

It should also be pointed out that a small number or all components of the device according to the invention may be made of a plastics material. Moreover, it should be pointed out that the catch element 28 in the example shown is configured as a single piece and may particularly be made of a softer material than the basic body 14 likewise configured as a single piece.

1. A device for connecting two conduit sections of a conduit of an automobile, comprising a plug element and a basic body with a receptacle for the plug element, wherein the plug element comprises at least one catch element and in that the receptacle comprises at least one catch element corresponding to the catch element of the plug element, wherein the catch elements releasably engage with each other upon insertion of the plug element into the receptacle, and in that a locking device is provided which impedes a release of the engagement of the catch elements in a locking position and which allows a release of the engagement of the catch elements in an unlocking position.

2. The device as claimed in claim 1, wherein the at least one catch element of the plug element is a circumferential groove provided on the outside of the plug element or a circumferential projection provided on the outside of the plug element.

3. The device as claimed in claim 1, wherein the at least one catch element of the receptacle comprises at least one catch arm which is elastic at least in the radial direction of the receptacle, wherein a catch projection is provided on the free end of the catch arm.

4. The device as claimed in claim 3, wherein the at least one catch arm is provided on a holding ring of the catch element with its end opposite the free end, wherein the holding ring is held on the basic body.

5. The device as claimed in claim 1, wherein the locking device comprises a locking sleeve provided on the basic body and being rotatable between the unlocking position and the locking position.

6. The device as claimed in claim 5, wherein in the locking position the locking sleeve impedes a movement of the at least one catch arm at least in the radial direction to the outside.

7. The device as claimed in claim 6, wherein the locking sleeve comprises an inner radius which changes in the circumferential direction, wherein in the locking position at least one section with a smaller inner radius is located in the radial direction above the catch projection of the at least one catch arm arm, so that the at least one catch arm cannot move in the radial direction to the outside and, wherein in the unlocking position at least one section with a larger inner radius is located in the radial direction above the catch projection of the at least one catch arm so that the at least one catch arm can move in the radial direction to the outside for releasing the engagement of the plug element in the receptacle.

8. The device as claimed in claim 7, wherein the locking sleeve comprises at least one receptacle for the at least one catch projection on its inner surface in the area of the at least one section with a larger inner radius.

9. The device as claimed in claim 3, wherein the at least one catch element of the receptacle further comprises a safety arm being elastic at least in the radial direction of the receptacle, wherein on the free end of the safety arm a safety projection is provided, wherein the at least one safety projection is offset in the axial direction with regard to the at least one catch projection of the catch element of the receptacle.

10. The device as claimed in claim 9, wherein the at least one safety arm is also provided on the holding ring being held on the basic body, with its end opposite the free end.

11. The device as claimed in claim 9, wherein the locking sleeve comprises at least one through-opening into which at least one safety projection enters in the locking position of the locking sleeve, so that a rotation of the locking sleeve from its locking position into its unlocking position is impeded.

12. The device as claimed in claim 1, wherein the plug element and/or the basic body and/or the catch elements consist of a plastic material.

13. The device as claimed in claim 1, wherein the basic body consists of a harder material than the at least one catch element of the receptacle.
